(19) United States
(12) Patent Application Publication
(10) Pub. No.: US 2021/0200758 A1
(43) Pub. Date: Jul. 1, 2021

(54) EDGE TABLE REPRESENTATION OF PROCESSES

(71) Applicant: UiPath, Inc., New York, NY (US)

(72) Inventors: Roeland Johannus SCHEEPENS, Eindhoven (NL); Roeland VLIEGEN, Waalre (NL)

(73) Assignee: UiPath, Inc., New York, NY (US)

(21) Appl. No.: 16/728,686

(22) Filed: Dec. 27, 2019

(51) Int. Cl. G06F 16/2458; G06F 16/22

(52) U.S. Cl. CPC G06F 16/2465; G06F 16/2282

(57) ABSTRACT

Systems and methods for representing execution of a process in an edge table are provided. Process execution data for a process including a plurality of activities is received. An edge table is generated representing execution of the process based on the process execution data. Each row of the edge table identifies a transition from a source event to a destination event.

### TECHNICAL FIELD

The present invention relates generally to process mining, and more particularly to representing the execution of processes in edge tables for process mining.

### BACKGROUND

In process mining, processes are analyzed to identify trends, patterns, and other process analytical measures in order to improve efficiency and gain a better understanding of the processes. Traditional processing mining involves applying data mining algorithms to event logs, which record events representing executed activities, a time stamp, and a case identifier. Event logs are typically stored as tables with each row (or record) of the table associated with a single event. Accordingly, metrics or other expressions may be easily computed on events based on the event logs. However, event logs do not reflect the transitions from a source event of the process to a destination event and, as such, metrics cannot be easily computed on the transitions from the event logs.

### BRIEF SUMMARY OF THE INVENTION

In accordance with one or more embodiments, systems and methods for representing execution of a process in an edge table are provided. The process may be a robotic process automation process.

Process execution data for a process including a plurality of activities is received. An edge table representing execution of the process is generated based on the process execution data. Each row of the edge table identifies a transition from a source event to a destination event.

In one embodiment, a process graph hierarchically representing execution of the process may be generated based on the edge table.

In one embodiment, one or more metrics are computed based on the edge table. The one or more metrics may be associated with the transition from the source event to the destination event and/or the destination event.

In one embodiment, the process execution data includes an event log of the process. The edge table is generated by sorting the event log based on a case identifier and a timestamp and adding rows to the edge table based on the sorted event log.

These and other advantages of the invention will be apparent to those of ordinary skill in the art by reference to the following detailed description and the accompanying drawings.

### BRIEF DESCRIPTION OF THE DRAWINGS

FIG. 1A shows an exemplary process for document processing;

FIG. 1B shows an exemplary process for invoice processing;

FIG. 2 shows a method for generating an edge table representing execution of the process, according to an embodiment of the invention;

FIG. 3 shows an illustrative edge table, according to an embodiment of the invention;

FIG. 4 shows an illustrative process graph hierarchically representing records of an execution of a process, according to an embodiment of the invention; and

FIG. 5 is a block diagram of a computing system according to an embodiment of the invention.

### DETAILED DESCRIPTION

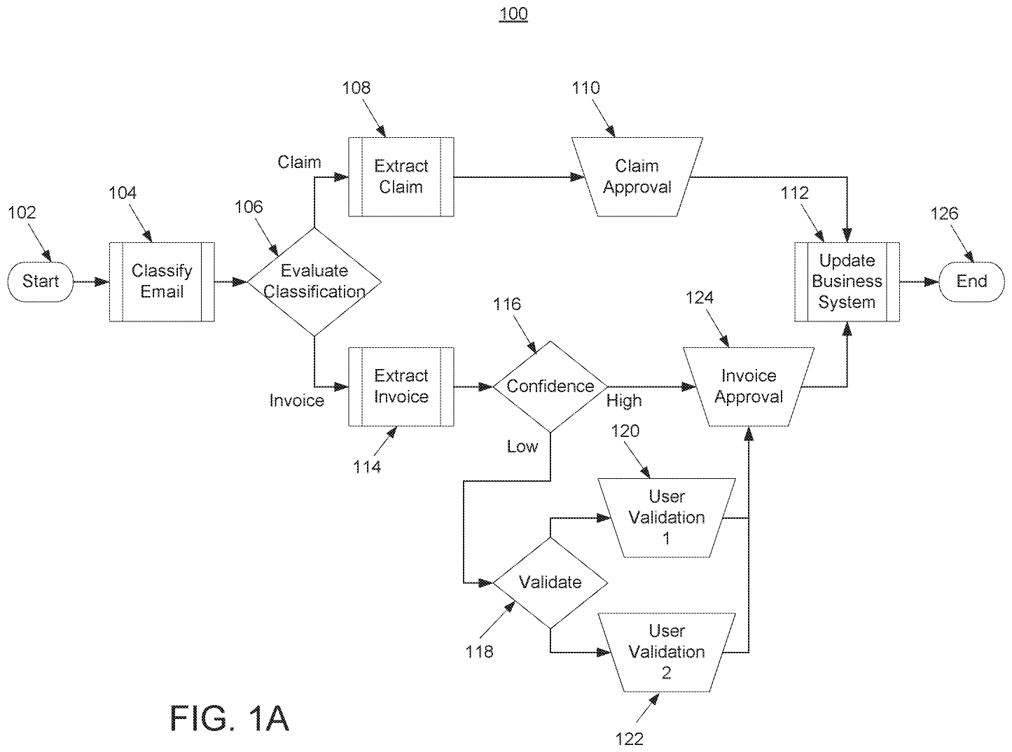

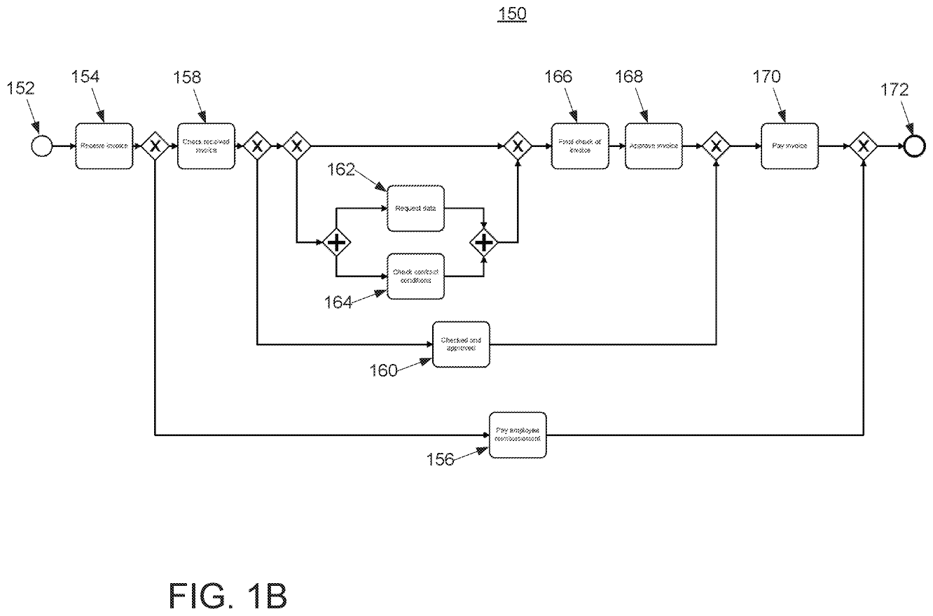

Process mining involves the analysis of a process to identify trends, patterns, and other process analytical measures. In accordance with embodiments of the present invention, process mining may be performed based on an edge table representing execution of the process. Each row of the edge table identifies a transition from a source event to a destination event of the execution of the process. Accordingly, metrics associated with the transition and/or the destination event may be computed from the edge table. An example of a process is shown in FIG. 1A as process 100 for document processing, which may be implemented as a robotic process automation (RPA) process. Another example of a process is shown in FIG. 1B as process 150 for invoice process, which may be implemented as a business workflow.

Process 100 is shown in FIG. 1A as an RPA workflow for automatic document processing performed using RPA robots. However, it should be understood that process 100 may be any suitable process that can be modelled as a workflow, such as, e.g., a business workflow. Process 100 comprises activities 102-126. As shown in FIG. 1A, process 100 is modeled as a directed graph where each activity 102-126 is represented as a node and each transition between activities is represented as edges linking the nodes. The transition between activities represents the execution of process 100 from a source activity to a destination activity.

Process 100 starts at start activity 102 and proceeds to activity 104, where an email is classified. At activity 106, the classification is evaluated. If the email is classified as a claim at activity 106, process 100 proceeds to extract the claim at activity 108 and to receive user input approving the claim at activity 110. The business system is updated with the claim approval at activity 112. If the email is classified as an invoice at activity 106, process 100 proceeds to extract the invoice at activity 114 and to evaluate the confidence in the extracted invoice at activity 416. If the confidence is low at activity 116, user input is received to validate the invoice data at activity 118 and user input is received to validate the invoice at activity 120 and activity 122. If the confidence is high at activity 116, process 100 proceeds directly to activity 124 to receive user input to approve the invoice. The business system is updated with the approved invoice at activity 112. Process 100 ends at end activity 126.

Process 150 is shown in FIG. 1B as a business workflow. Process 150 comprises activities 152-172 and is modeled as a directed graph where each activity 152-172 is represented as a node and each transition between activities is represented as edges linking the nodes. The transition between activities represents the execution of process 150 from a source activity to a destination activity.

Process 150 starts at start activity 152 and proceeds to activity 154, where an invoice is received. Process 150 proceeds to either activity 156 to pay an employee a reimbursement and to end activity 172 to end process 150, or to activity 158 to check the received invoice. The invoice will either be approved at activity 160 or process 150 will proceed to either request data at activity 162 and check contract conditions at activity 164, or proceed directly to activity 166 to perform a final check of the invoice and activity 168 to approve the invoice. The invoice is paid at activity 170 and process 150 ends at end activity 172.

Conventionally, as a process (e.g., process 100 or 150) is executed, an event log is generated. The event log is typically formatted as a table having rows and columns. Each row (or record) of the event log is associated with an event representing an executed activity, a time stamp, a case identifier (ID), and possibly additional information, which are identified in respective columns. While such conventional event logs allow metrics to be computed on each event, such conventional event logs do not reflect transitions between events and accordingly do not allow metrics to be easily computed for such transitions, particularly for processes that include parallelism, such as shown with respect to activities 108 and 114 in process 100 of FIG. 1A. Metrics on parallel events cannot be easily computed with an event table, and are difficult to use in accompanying business intelligence (BI) charts, such as (e.g., bar charts).

Embodiments of the present invention generate an edge table representing the execution of a process (e.g., process 100 or 150), where each row of the edge table is associated with a transition between events. Each row of the edge table can therefore represent a record of the transition from the source event to the destination event, as well as a record of the destination event. Advantageously, an edge table in accordance with embodiments of the present invention facilitates computation of metrics (or other expressions) associated with the transitions and/or on the destination event, thereby allowing a single metric to be used to evaluate the transitions and the events. Additionally, an edge table in accordance with embodiments of the present invention may be important if an event log, while available, is not generated.

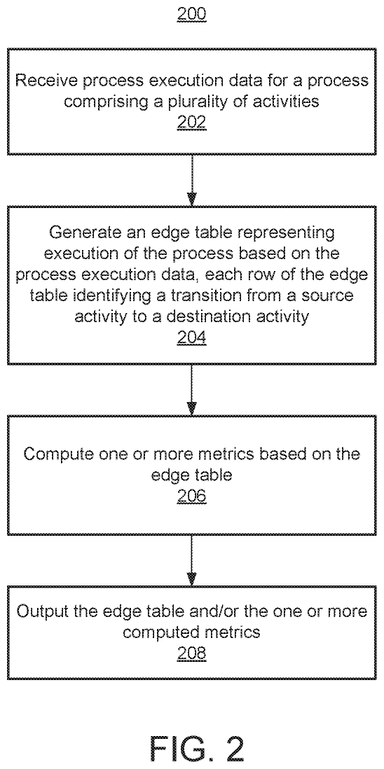

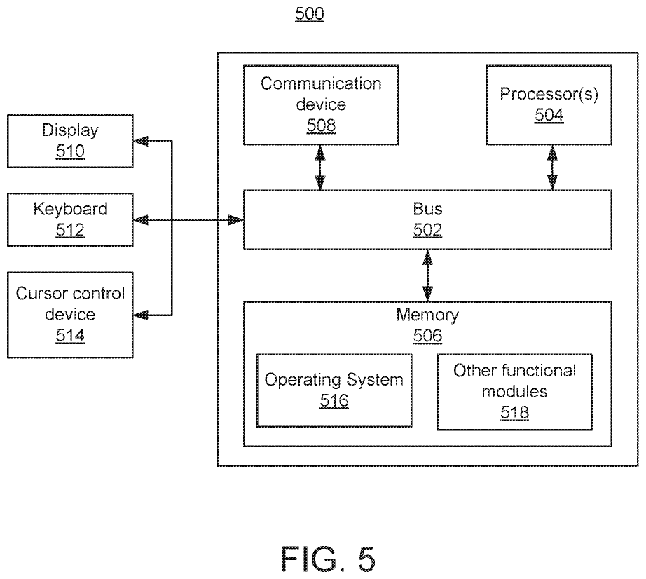

FIG. 2 shows a method 200 for generating an edge table representing execution of a process, in accordance with one or more embodiments. Method 200 may be performed by any suitable computing device, such as computer 500 of FIG. 5.

At step 202, process execution data for a process comprising a first activity and a second activity is received. In one embodiment, the process execution data may be an event log of the execution of the process. However, it should be understood that the process execution data may include any data representing the execution of the process, such as, e.g., a process model or an output of a conformance checking algorithm.

At step 204, an edge table representing execution of the process is generated based on the process execution data. Each row of the edge table identifies a transition from a source event to a destination event. In order to generate the edge table, attributes of the source event and the destination event are defined from the process execution data for each transition.

In one embodiment, for example where the process execution data is an event log of the execution of the process, the edge table may be generated by first sorting all events in the event log based on their case ID, and then sorting each event with the same case ID by timestamp (from earliest to most recent). Then, the following steps are sequentially performed over the sorted event log in one pass for each respective event in the event log. First, if the sorted event log does not have a prior event with the same case ID as the respective event, a new row is added to the edge table having a null event as the source event and the respective event as the destination event. This allows a first event in a case to be listed as a destination event. Second, if the sorted event log has a prior event with the same case ID as the respective event, a new row is added to the edge table having the immediately prior event as the source event and the respective event as the destination event. For each new row added to the edge table, an event ID is assigned to each event and additional attributes may be added to events in the event log using the event IDs such that each row of the edge table comprises attributes of the source event and the destination event.

In one embodiment, for example where the process execution data is a BPMN (business process model and notation) process model, the edge table may be generated by storing each edge in the process model as a single transition between its source activity and its destination activity. The edge table may optionally include columns identifying the model node type of the node associated with the source activity and the node associated with the destination activity. The model node type represents the semantics of the node and may be one of the following: Activity, And gateway, Xor gateway, Start, or End. Other node types are also contemplated. The nodes types are determined from mining algorithms or direct input). The model node type stored in the edge table allows the node type of be uniformly reused in process graphs and BI charts.

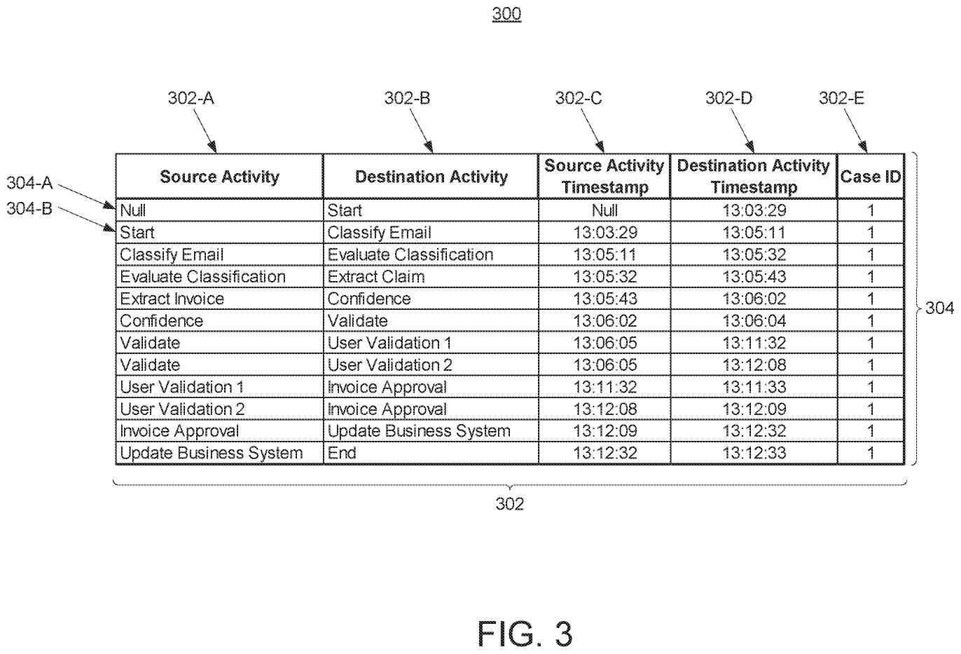

FIG. 3 shows an illustrative edge table 300, in accordance with one or more embodiments. Edge table 300 may be generated at step 204 of FIG. 2. Edge table 300 of FIG. 3 represents the execution of process 100 and will be described with reference to FIG. 1A. Edge table 300 includes columns 302 and rows 304. Each row 304 in edge table 300 identifies a transition from a source event to a destination event. Each column 302 in edge table 300 is associated with a field identifying various attributes of the source event and the destination event for each row 304. For example, column 302-A identifies a source activity, column 302-B identifies a destination activity, column 302-C identifies a source activity timestamp, column 302-D identifies a destination activity timestamp, and column 302-E identifies a case ID. Edge table 300 may include additional columns 302 identifying additional attributes, such as, e.g., names or service level agreements.

As shown in FIG. 3, row 302-A identifies a null source activity in column 302-A, start activity 102 as the destination activity in column 302-B, a null timestamp as the source activity timestamp in column 302-C, a timestamp of 13:03:29 as the destination activity timestamp in column 302-D, and a case ID of 1 in column 302-E. Row 302-A identifying a transition from a null event to a start event enables metrics to be computed on the start event. Row 304-B identifies start activity 102 as the source activity in column 302-A, classify email activity 104 as the destination activity in column 302-B, a timestamp of 13:03:29 as the source activity timestamp in column 302-C, a timestamp of 13:05:11 as the destination activity timestamp in column 302-D, and a case identifier of 1 in column 302-E. The remaining transitions between events are similarly identified in edge table 300. While the null activity is illustratively shown in FIG. 3, other implementations are also possible. As shown in edge table 300, the order of activities 102-126 is implicitly provided by the transition relationship in each row 304.

At step 206 of FIG. 2, one or more metrics are computed based on the edge table. The metrics may be associated with the transition from the source event to the destination event and/or may be associated with the destination event. The metrics may include any suitable metrics. In one example, the metrics may include a number of events, computed as the number of rows or records in the edge table. In another example, the metrics may include the number of cases, computed as the number of unique case IDs identified in the edge table. In another example, the metrics may include a case percentage, computed as the percentage of the number of unique case IDs identified in the edge table relative to the total number of case IDs. In another example, the metrics may include an average throughput time, computed as the average of the throughput time for all activities. Other metrics may also be computed based on the edge table. The metrics may be used for visualizing exception handling, parallelism, multi-instance graphs, conformance checking, custom key performance indicators, or any other application. In some embodiments, the computed metrics may be stored as attributes within the edge table.

At step 208, the edge table and/or the one or more computed metrics are output. For example, the edge table and/or the computed metrics can be output by displaying the edge table and/or the computed metrics on a display device of a computer system, storing the edge table and/or the computed metrics on a memory or storage of a computer system, or by transmitting the edge table and/or the computed metrics to a remote computer system.

Advantageously, an edge table in accordance with embodiments of the present invention enable a single metric to be defined for both the destination event and the transition from the source event to the destination event using a single table. In one example, the edge table enables computation of metrics on transitions in the case of parallelism, where there is no particular order between activities (i.e., the activities can be performed in any order). Event logs are sequential and cannot capture the concept of parallelism.

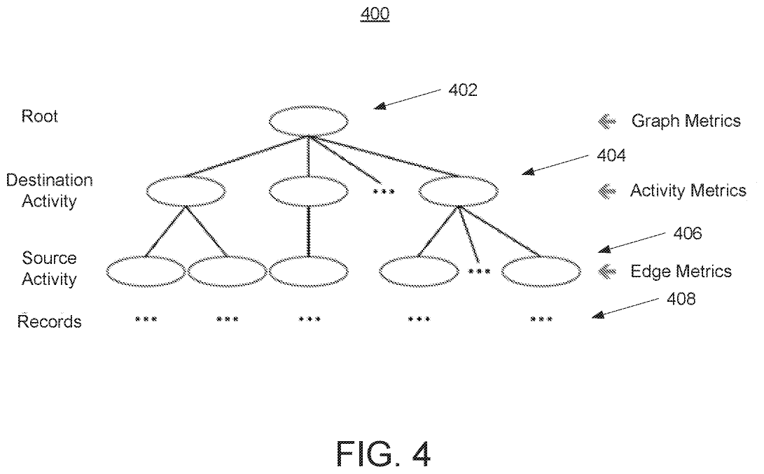

In one embodiment, a process graph hierarchically representing records of the execution of the process of method 200 may be generated based on the edge table to facilitate computation of metrics. FIG. 4 shows an illustrative process graph 400 hierarchically representing records of an execution of a process, in accordance with one or more embodiments. Each node in process graph 400 comprises a set of records identifying transitions from a source event to a destination event.

Process graph 400 facilitates the computation of metrics at a root level 402, a destination activity level 404, a source activity level 406, and a records level 408. Root level 402 comprises a root node including all records. Metrics over the entire process can be computed at the root node. Destination activity level 404 comprises nodes each associated with a unique destination activity. Each node at destination activity level 404 comprises all records for its associated destination activity. Metrics for destination activities may be computed at nodes of destination activity level 404. Source activity level 406 comprises nodes each associated with a unique combination of source activity and destination activity. Each node at source activity level 406 comprises all records from its parent node with the same source activity. Therefore, each node at source activity level 406 comprises all records for its associated source activity and destination activity. Metrics for a transition from a source activity to a destination activity may be computed at nodes of source activity level 406. Records level 408 represent the individual records of the edge table. Metrics may be computed at records level 408, however the metric would be computed for an individual transition.

Process graph 400 may be generated using the edge table to define the source/destination relationship between events. In particular, process graph 400 may be generated from the edge table by placing each row (or record) of the edge table in its associated nodes (i.e., in the root node, the destination activity level node with the same destination activity, and the source activity level node with the same source and destination activities).

Metrics may be computed using process graph 400. For example, graph metrics may be computed on the entire process from root level 402, activity metrics may be computed on destination activity level 404, and/or metrics on transitions may be computed on source activity level 406. Each node of process graph 400 can access its parent and its child nodes. Therefore, for example, when computing a metric of a transition, the properties of all records with the same destination activity as that edge can be used. For example, the metric of case percentage returns the percentage of cases that traverse a particular transition by computing the number of unique case IDs determined from a node at the source activity level 406 divided by the total number of unique case IDs in the entire process determined from the root node at root level 402, and converting the result into a percentage.

In one embodiment, transitions between events in an edge table can be represented directly in BI charts. The edge table may be filtered or enhanced, and the resulting edge table may be shown directly as a process graph and/or a BI chart. The edge table may act as a normal table in a BI system, resulting in all BI functionality, such as, e.g., filtering, selection, calculating metrics, joining to other tables, adding new (derived) attributes, etc., available on transitions in the edge table.

Various embodiments of the present invention will now be discussed. In one embodiment, an edge table may be used to check conformance of another event log. The conformance model may be generated or imported from, e.g., a BPMN model. In one embodiment, an edge table may be used to add activities and transitions that are not part of the event log to, e.g., add missing parts of the process or to add a common start and/or end activity.

In one embodiment, an edge table may be used as a cache to speed up process calculations. In one embodiment, an edge table may be joined with the event log. In one embodiment, an edge table comprises all information of the event log.

In one embodiment, an edge table can directly express parallelism, e.g., as mined from an event log using a process mining algorithm or as directly encoded in the input data. The parallelism information is also directly available for BI charts. Encoding the parallelism explicitly makes it possible to calculate metrics that correctly take parallelism into account. Parallelism is often ignored in traditional process mining.

In one embodiment, an edge table has one row per transition and represents a model. In one embodiment, an edge table has one row per event and represents all transitions of an event log.

FIG. 5 is a block diagram illustrating a computing system 500 configured to execute the methods described in reference to FIG. 2, according to an embodiment of the present invention. In some embodiments, computing system 500 may be one or more of the computing systems depicted and/or described herein. Computing system 500 includes a bus 502 or other communication mechanism for communicating information, and processor(s) 504 coupled to bus 502 for processing information. Processor(s) 504 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 504 may also have multiple processing cores, and at least some of the cores may be configured to perform specific functions. Multi-parallel processing may be used in some embodiments.

Computing system 500 further includes a memory 506 for storing information and instructions to be executed by processor(s) 504. Memory 506 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 504 and may include volatile media, non-volatile media, or both. The media may also be removable, non-removable, or both.

Additionally, computing system 500 includes a communication device 508, such as a transceiver, to provide access to a communications network via a wireless and/or wired connection according to any currently existing or future-implemented communications standard and/or protocol.

Processor(s) 504 are further coupled via bus 502 to a display 510 that is suitable for displaying information to a user. Display 510 may also be configured as a touch display and/or any suitable haptic I/O device.

A keyboard 512 and a cursor control device 514, such as a computer mouse, a touchpad, etc., are further coupled to bus 502 to enable a user to interface with computing system. However, in certain embodiments, a physical keyboard and mouse may not be present, and the user may interact with the device solely through display 510 and/or a touchpad (not shown). Any type and combination of input devices may be used as a matter of design choice. In certain embodiments, no physical input device and/or display is present. For instance, the user may interact with computing system 500 remotely via another computing system in communication therewith, or computing system 500 may operate autonomously.

Memory 506 stores software modules that provide functionality when executed by processor(s) 504. The modules include an operating system 516 for computing system 500 and one or more additional functional modules 518 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer-implemented method comprising:
receiving process execution data for a process comprising a plurality of activities;
generating an edge table representing execution of the process based on the process execution data, each row of the edge table identifying a transition from a source event to a destination event; and
outputting the edge table.

2. The computer-implemented method of claim 1, wherein the process execution data comprises an event log of the process.

3. The computer-implemented method of claim 2, wherein generating an edge table representing execution of the process based on the process execution data comprises:
sorting the event log based on a case identifier and a timestamp; and
adding rows to the edge table based on the sorted event log.

4. The computer-implemented method of claim 1, further comprising:
computing one or more metrics based on the edge table.

5. The computer-implemented method of claim 4, wherein computing one or more metrics based on the edge table comprises:
computing one or more metrics associated with the transition from the source event to the destination event.

6. The computer-implemented method of claim 4, wherein computing one or more metrics based on the edge table comprises:
computing one or more metrics associated with the destination event.

7. The computer-implemented method of claim 1, further comprising:
generating a process graph hierarchically representing the execution of the process based on the edge table.

8. The computer-implemented method of claim 1, wherein the process is a robotic process automation process.

9. An apparatus comprising:
a memory storing computer instructions; and
at least one processor configured to execute the computer instructions, the computer instructions configured to cause the at least one processor to perform operations of:
receiving process execution data for a process comprising a plurality of activities;
generating an edge table representing execution of the process based on the process execution data, each row of the edge table identifying a transition from a source event to a destination event; and
outputting the edge table.

10. The apparatus of claim 9, wherein the process execution data comprises an event log of the process.

11. The apparatus of claim 10, wherein generating an edge table representing execution of the process based on the process execution data comprises:
sorting the event log based on a case identifier and a timestamp; and
adding rows to the edge table based on the sorted event log.

12. The apparatus of claim 9, the operations further comprising:
computing one or more metrics based on the edge table.

13. The apparatus of claim 12, wherein computing one or more metrics based on the edge table comprises:
computing one or more metrics associated with the transition from the source event to the destination event.

14. The apparatus of claim 12, wherein computing one or more metrics based on the edge table comprises:
computing one or more metrics associated with the destination event.

15. The apparatus of claim 9, the operations further comprising:
generating a process graph hierarchically representing the execution of the process based on the edge table.

16. The apparatus of claim 9, wherein the process is a robotic process automation process.

17. A computer program embodied on a non-transitory computer-readable medium, the computer program configured to cause at least one processor to perform operations comprising:
receiving process execution data for a process comprising a plurality of activities;
generating an edge table representing execution of the process based on the process execution data, each row of the edge table identifying a transition from a source event to a destination event; and
outputting the edge table.

18. The computer program of claim 17, wherein the process execution data comprises an event log of the process.

19. The computer program of claim 18, wherein generating an edge table representing execution of the process based on the process execution data comprises:
sorting the event log based on a case identifier and a timestamp; and
adding rows to the edge table based on the sorted event log.

20. The computer program of claim 17, the operations further comprising:
computing one or more metrics based on the edge table.

21. The computer program of claim 20, wherein computing one or more metrics based on the edge table comprises:
computing one or more metrics associated with the transition from the source event to the destination event.

22. The computer program of claim 20, wherein computing one or more metrics based on the edge table comprises:
computing one or more metrics associated with the destination event.

23. The computer program of claim 17, the operations further comprising:
generating a process graph hierarchically representing the execution of the process based on the edge table.

24. The computer program of claim 17, wherein the process is a robotic process automation process.
